(19) United States
(12) Patent Application Publication
(10) Pub. No.: US 2007/0256643 A1
(43) Pub. Date: Nov. 8, 2007

(54) Remote animal cage environmental monitoring and control system

(76) Inventors: Michael A. Coiro, Jacobstown, NJ (US); Steven J. Miller, Allentown, NJ (US); David L. Curtin, East Windsor, NJ (US)

Correspondence Address: MATHEWS, SHEPHERD, MCKAY, & BRUNEAU, P.A., 29 THANET ROAD, SUITE 201, PRINCETON, NJ, 08540, US

(21) Appl. No.: 11/473,171

(22) Filed: Jun. 21, 2006

Related U.S. Application Data
(60) Provisional application No. 60/692,467, filed on Jun. 21, 2005.
(60) Provisional application No. 60/733,969, filed on Nov. 4, 2005.

(51) Int. Cl. A01K 39/012

(52) U.S. Cl. 119/457

(57) ABSTRACT

A system provides for the automatic remote monitoring and control of the environment of ventilated racks of animal cages and corresponding equipment through wireless interfaces. The system has a query means for querying a plurality of status parameters of a ventilated rack of animal cages, an evaluation means for evaluating the plurality of status parameters automatically, an alert means for alerting a digital system of the plurality of status parameters, a receiving means receiving control input from the digital system, and a wireless interface for communicating the plurality of status parameters wirelessly to an access point and for communicating the control input wirelessly from the access point to the ventilated rack of animal cages. Wherein the system enables that the environment of the ventilated racks of animal cages and corresponding equipment is remotely monitored. A method is also disclosed.

### CROSS REFERENCES TO RELATED APPLICATIONS

This application claims the benefit under 35 U.S.C. 119(e) of U.S. Provisional Application Ser. No. 60/692,467, entitled Remote Animal Cage Environmental Monitoring And Control System, filed on Jun. 21, 2005, U.S. Provisional Application Ser. No. 60/733,969, entitled System For Environmental Monitoring And Control Of Animal Cages And Ambient Conditions, filed on Nov. 4, 2005, and U.S. Provisional Application Ser. No. 60/___,___, entitled Further Features Of A System For Remote Environmental Monitoring And Control Of Animal Cages and Ambient Conditions, filed on Jun. 20, 2006.

### FIELD OF INVENTION

The present invention relates to animal cages and more particularly to monitoring systems for ventilated racks of animal cages. BACKGROUND OF THE INVENTION

Animal cages are typically used in groups which are often stacked on racks. Air and water must be provided to the individual animal cages. Systems for providing air to and removing exhaust from racks of animal cages are known, such as U.S. Pat. No. 5,307,757 entitled Ventilated Rack And Animal Cage System. Systems for providing water to the animal cages include two major types: automated watering coupled to a continuous water supply; and, an individual water bottle.

U.S. Pat. No. 6,308,660 entitled Bio-Containment Animal Cage System describes a self-sealing animal cage removably connected to an air supply and an exhaust. The self-sealing animal cage is supported by a rack. The self-sealing animal cage is sealed by an air inlet connection and an air outlet connection to the air supply and the exhaust connection. After the cages are removed from the air supply and the exhaust, the air inlet connection and the exhaust connection seals the cage to prevent air from entering or exiting the cage. Accordingly, the animal caging system provides isolation of the self-sealing animal cage and provides containment of airborne pathogens within the caging system. A bio-sensing cage is used in the animal cage system to measure pressure of animal cage connected to the air supply and exhaust which contains an animal. The measurement of pressure in the bio-sensing cage is used by a controller to maintain pressure in the cages independently of environment and cage conditions.

The value of laboratory animals far exceeds their commercial cost. The laboratory animals may be the result of a sequence of tests and breeding which would require extensive time to reproduce if even possible. Failure of the environmental and cage conditions caused by component failure, system failure or problems, building environmental problems as well as human error and/or deliberate acts needs to be continuously and carefully monitored. Individual monitoring of racks is costly, time consuming and error prone.

Therefore there is a need for a reliable and efficient system to continuously monitor laboratory animal cages and racks.

### SUMMARY OF THE INVENTION

The present invention is a system for automatic remote monitoring and control of the environment of ventilated racks of animal cages and corresponding equipment through wireless interfaces. The system comprises: query means for querying a plurality of status parameters of a ventilated rack of animal cages; evaluation means for evaluating the plurality of status parameters automatically; alert means for alerting a digital system of the plurality of status parameters; receiving means receiving control input from the digital system; and wireless interface for communicating the plurality of status parameters wirelessly to an access point and for communicating the control input wirelessly from the access point to the ventilated rack of animal cages; wherein the environment of the ventilated racks of animal cages and corresponding equipment is remotely monitored.

### BRIEF DESCRIPTION OF THE DRAWINGS

A more complete understanding of the present invention may be obtained from consideration of the following description in conjunction with the drawings in which:

FIG. 1 is a sentinel cage sampling system in use with the present invention remote animal cage environmental monitoring and control system;

FIG. 2 is a bio-containment animal cage system in use with the present invention remote animal cage environmental monitoring and control system;

FIG. 3 is an illustration of an animal cage system for larger animals with the remote animal cage environmental monitoring and control system;

FIG. 4 is a high level functional diagram of the remote animal cage environmental monitoring and control system;

FIG. 5 is an exemplary screen display showing a visual basic interface to display the data from one set of blowers; and.

FIG. 6 is an illustration of a high-level system diagram.

### DETAILED DESCRIPTION OF VARIOUS ILLUSTRATIVE EMBODIMENTS

Reference will now be made in greater detail to a preferred embodiment of the invention, an example of which is illustrated in the accompanying drawings. Wherever possible, the same reference numerals will be used throughout the drawings and the description to refer to the same or like parts.

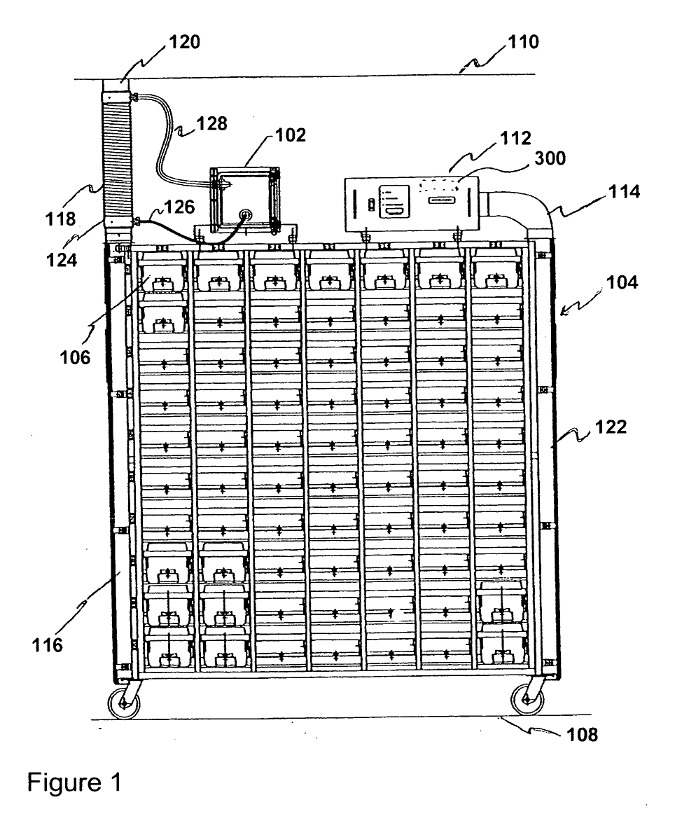

Referring to FIG. 1 there is shown the present invention remote animal cage environmental monitoring and control system 300 in use with Micro-VENT environmental housing units having a sentinel cage sampling system for airborne pathogens. A sentient chamber 102 is mounted on top of a Micro-VENT rack 104 with Micro-VENT cages 106. The rack 104 is shown movably located on a floor 108. Exhaust ventilation from the rack 104 is vented from the room through an exhaust ducting 120 which exits through a ceiling 110. The remote animal cage environmental monitoring and control system 300 is integral to an air source 112, which typically is HEPA filtered, is attached to an inlet duct 114 (although alternatively a suitable room air supply may also be used). The inlet duct 114 is coupled to a distribution duct/piping system 122 which provides the supply air to individual cages 106. An exhaust duct/piping system 116 is coupled to the individual cages 106, thus controlling air exiting from the cages 106 mounted on the rack 104. The exhaust duct/piping system 116 is coupled to the exhaust ducting 120 through a flexible coupling 118.

While the present invention remote animal cage environmental monitoring and control system 300 is shown in use with Micro-VENT environmental housing units and corresponding rack 100, it is also equally applicable to use with other types of cages, including cages using a room air supply which is filtered at the cage with a micro-barrier, such as a Micro-BARERIER Top with a filter that snaps in. A filter such as the Reemay™ filter medium (2295) 18 mils protects the animals from dust particles which may carry a virus or other pathogen. Additionally the present invention sentinel cage sampling system for airborne pathogens is well suited for use with a bio containment caging system.

The present invention remote animal cage environmental monitoring and control system 300 is particularly well suited for use with a Bio-Containment Animal Cage System which is disclosed by U.S. Pat. No. 6,308,660 and is incorporated herein by reference. The bio-containment animal cage system is a self-sealing animal cage removably connected to an air supply and an exhaust. The self-sealing animal cage is supported by a rack. The self-sealing animal cage is sealed by an air inlet connection and an air outlet connection to the air supply and the exhaust connection. After the cages are removed from the air supply and the exhaust, the air inlet connection and the exhaust connection seals the cage to prevent air from entering or exiting the cage. Accordingly, the animal caging system provides isolation of the self-sealing animal cage and provides containment of airborne pathogens within the caging system. A bio-sensing cage is used in the animal cage system to measure pressure of animal cage connected to the air supply and exhaust which contains an animal. The measurement of pressure in the bio-sensing cage is used by a controller to maintain pressure in the cages independently of environment and cage conditions.

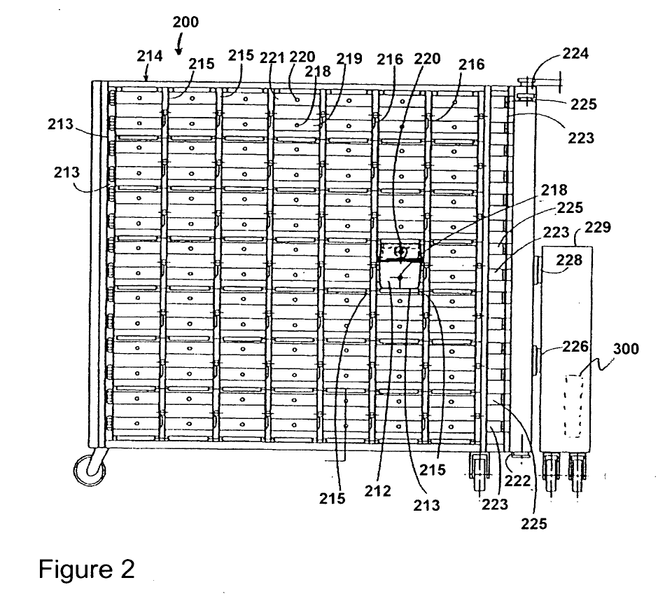

Referring to FIG. 2 there is shown an illustration of a bio-containment animal cage system 200 with the remote animal cage environmental monitoring and control system 300. Individual self-sealing animal cages 212 are supported on at least one platform 213 of rack 214. Preferably, platform 213 is substantially horizontal. Individual self-sealing cages 212 are guided into rack 214 with cage guides 215. Latch bracket 216 is attached to cage guides 215. After individual self-sealing cages 212 are inserted into rack 214, latch bracket 216 automatically locks self-sealing animal cages 212 to rack 214. For example, latch bracket 216 can be a quick disconnect locking mechanism which is engaged when self-sealing animal cage 212 is inserted into rack 214. Individual self-sealing animal cages 212 are sealed to prevent air from entering or exiting self-sealing animal cage 212 when self-sealing animal cage 212 is removed from rack 214.

The bio-containment rack and animal cage system 200 illustrated in FIG. 2 has seven platforms 213 located in rack 214. Each platform 213 includes eight cage guides 215 for accommodating seven self-sealing animal cages 212 between respective pairs of cage guides 215. Accordingly, bio-containment rack and animal system 210 can accommodate forty-nine self-sealing animal cages 212 on the front side and forty-nine cages on the rear side for a total of ninety-eight cages. The number of platforms 213 and cage guides 15 can be varied according to the needs of the user.

Air inlet connection 218 connects each self-sealing animal cage 212 to horizontal air supply plenum 219. Exhaust outlet connection 220 connects each self-sealing animal cage 212 to horizontal exhaust plenum 221. Air inlet connection 218 and exhaust outlet connection 220 are sealed when self-sealing animal cage 212 is removed from horizontal air supply plenum 219 and horizontal exhaust plenum 221. Supply plenum connection 223 connects horizontal air supply plenum 219 to vertical air supply plenum 222. Exhaust plenum connection 225 connects horizontal exhaust plenum 221 to vertical exhaust plenum 224. It will be appreciated that horizontal air supply plenum 219 and horizontal exhaust plenum 221 can be angled from the horizontal and vertical air supply plenum 222 and vertical exhaust plenum 224 can be angled from vertical. Air supply connection 226 connects vertical air supply plenum 222 and exhaust connection 228 connects vertical air exhaust plenum 224 to air delivery and exhaust apparatus 229 with integral remote animal cage environmental monitoring and control system 300.

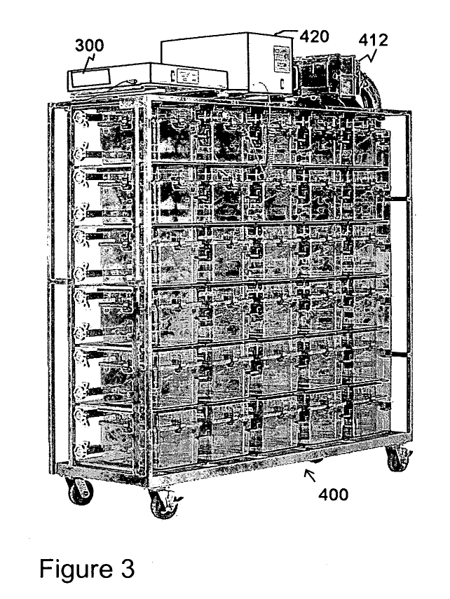

Referring to FIG. 3 there is shown an illustration of an animal cage system 400 for larger animals with the remote animal cage environmental monitoring and control system 300. The animal cage system includes an automatic battery back up 410. The blower/air supply system 420 uses dual HEPE Filter assemblies in parallel 412 to provide the increased air volume for the larger cages. The blower/air supply system 420 incorporates an integral remote animal cage environmental monitoring and control system 300. While the remote animal cage environmental monitoring and control system 300 is particularly well suited for integration into the air supply control system and is so described herein it is equally well suited for adaptation and retrofitting to existing air supply control systems having suitable interfaces for accessing the necessary data.

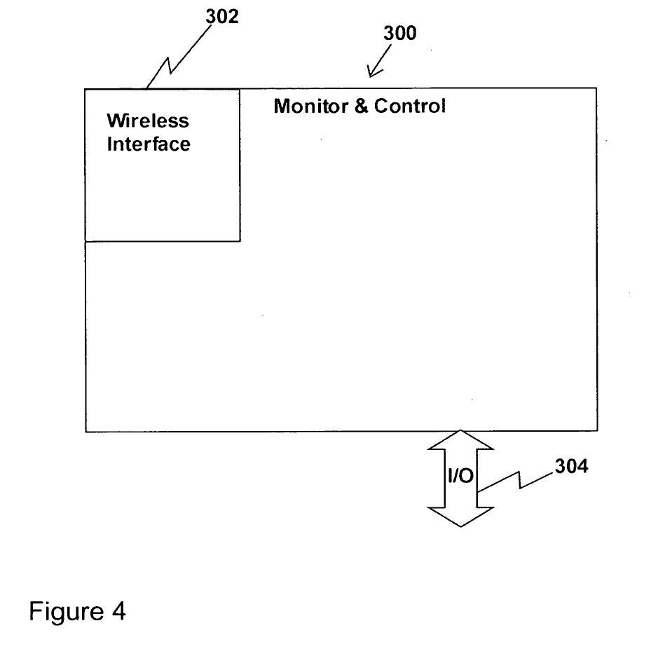

Referring to FIG. 4 there is shown a high level functional diagram of the remote animal cage environmental monitoring and control system. The remote animal cage environmental monitoring and control system 300 incorporates a wireless interface 302 such as IEEE 802.15 Bluetooth, but is equally well suited for other bidirectional wireless interfaces including but not limited to various WiFi and other wireless interfaces, including but not limited to IR (infrared radiation) wireless, various RF wireless links, cellular & PCS links, wireless TCP/IP interfaces as well as other systems and protocols that are known to those skilled in the wireless communication art. Senor, monitor signal and control links 304 interface between the remote animal cage environmental monitoring and control system 300 and the micro environment and ventilated rack equipment including the blower and other systems.

A further embodiment employs a communication interface such as an Ethernet link such as 10/100/1000BASE-T, USB, IEEE 1394, as well as utilize an ASIC (application specific integrated circuit) with a priority protocol.

Laboratory animal cages are designed to be moved such as for cleaning, changing, and experimental work. One problem that occurs is that any wired interface is prone to being left unplugged or may be loosely or poorly plugged in and later fail. The use of a the wireless interface and battery backup not only eliminates these points of failure in monitoring but also enables the automatic tracking of the cage status such as when it is being cleaned, etc. In one embodiment the blower uses DC motors and controls which can be driven by the battery backup in a mode of operation of a Uninterruptible Power Supply (UPS) system.

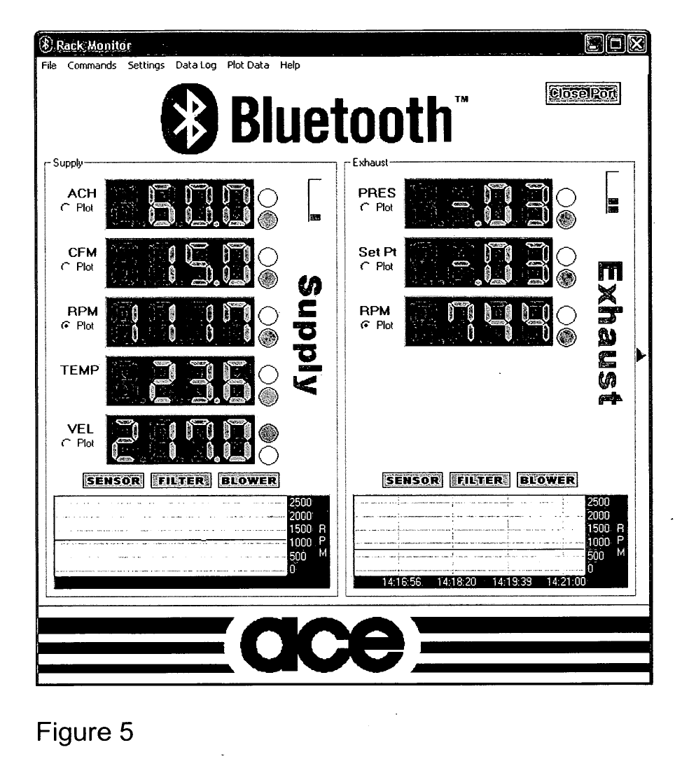

Referring to FIG. 5 there is shown an exemplary screen display showing a Visual Basic interface to display the data from one of the blowers at a given time provided by the remote animal cage environmental monitoring and control system 300. ACH (Air Change per Hour), CFM (Cubic Feet Per Minute), supply blower RPM (Revolutions per Minute), cage temperature, air flow velocity, cage pressure, exhaust pressure, exhaust blower RPM (Revolutions per Minute) and other parameters are displayed. The remote animal cage environmental monitoring and control system 300 provides for the polling of multiple blowers as well as other sensors and parameters. Although this embodiment is described as programmed in Visual Basic it is equally well suited for implementation in many other programming languages such as C, C++, Java, various object oriented languages and systems, as well as numerous other languages known to those skilled in the programming art.

Ambient conditions that can be monitored include temperature, humidity, light levels, building power such as power to the system, communication system and network status, building security, and various other relevant and meaningful data. Decisions can be set to be made by the system based upon the event that occurs, the external response that occurs, and follow up provided to escalate the response and communication alternatives. Automated responses can be manually activated remotely including switching to a backup system in view of pending failure, securing an area because of a security breach, as well as activating emergency environmental controls.

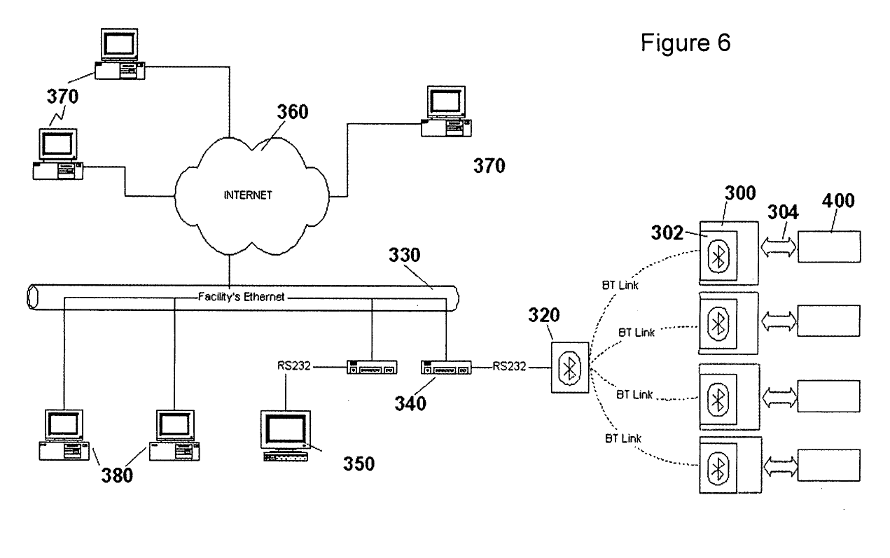

Referring to FIG. 6 there is shown the remote animal cage environmental monitoring and control system 300 with wireless interface 302 that communicates with an access point 320. Access point 320 is connected (wirelessly or wired) to a Local Area Network 330 and/or directly to a computer device 340.

The remote animal cage environmental monitoring and control system 300 provides information about the animal cage system including but not limited to: identifier information such as a model number, serial number and/or other identifier; pressure set points; pressure readings; fan rpm for a plurality of fans; power status; power use; voltage; blower status; filter status; ambient temperature; air inlet temperature; air exhaust temperature; ambient humidity; air inlet humidity; air exhaust humidity; ambient sound; animal cage still images; animal cage video images; floor water/moisture; and other parameters such as water flow rate, etc. The remote animal cage environmental monitoring and control system 300 can be used to change parameters and set points, switch to a backup fan/blower etc.

The access point 320 is connected to the facility network 330 through hub 340 or other suitable connection. Local browsers 380 and a local computer system 350 can securely access the remote animal cage environmental monitoring and control system 300. The facility network 330 is securely connected through a fire wall and with encryption to the internet 360. Remote browsers 370 can securely connect the facility network 330 to access the remote animal cage environmental monitoring and control system 300. Remote connections can include PDAs (personal digital assistants) with wireless interfaces, pagers, e-mail devices including BlackBerry® type devices, digital cell phones with text messaging and other devices known to those skilled in the art.

The access point 320 enables a plurality of remote animal cage environmental monitoring and control system 300 to be interfaced through their corresponding wireless interface 302. Thus enabling a dynamic reconfiguration and positioning of animal cage systems as necessary for cleaning, security, and as the work environment may so dictate.

The computer device 340 can be programmed to monitor the data provided by a plurality of remote animal cage environmental monitoring and control systems 300. Suitable automated responses can be initiated when an alarm/failure is observed with appropriate automatic elevation of responses until they are resolved remotely or on site. Furthermore, by monitoring pressure changes, temperature changes and fan RPM changes pending failures can be anticipated allowing controlled maintenance to be made at a suitable time, such as cleaning, etc. rather than waiting for a failure to occur which then requires an emergency response.

The network may also be a secured intranet, as well as other types of digital networks employing suitable technology.

The present invention when used with a bio-containment animal cage system, in addition to monitoring the environmental conditions of the cages, the associated ventilation and filtering elements and water supply, the status of the cage security can also be monitored. This may be done by a variety of proximity and access security systems, including RFID, user security badges as GPS systems, and other location systems. Individuals may be monitored to determine if they have the proper clearance and/or authority to open the animal cages. After hour and other abnormal events can be used to trigger a remove alert which may then be used to selectively secure and contain an unauthorized or unexpected event with a suitable response being initiated by the system

The present invention when used with a micro-environment animal cage transport unit, in addition to monitoring the environmental conditions of the cages, the associated ventilation and filtering elements and water supply, the physical position and status of the cage security can be monitored. This may be done by a variety of proximity systems, including RFID, GPS systems, and other location systems. Individuals may be monitored to determine if they have the proper clearance and/or authority to move and/or open the animal cages. After hour and other abnormal events can be used to trigger a remove alert which may then be used to selectively secure and contain an unauthorized or unexpected event with a suitable response being initiated by the system.

Although the present invention is suited for implementation as an independent software systems, the present invention is equally well suited for implementation as a functional/library module, an applet, a plug in software application, as a device plug in, in a microchip implementation; programmable device, etc. The system can be implemented as an embedded device, such as an application specific integrated circuit (ASIC), an integrated circuit chip set, ePROM, ROM, application board, or within a larger integrated circuit.

Numerous modifications and alternative embodiments of the invention will be apparent to those skilled in the art in view of the foregoing description. Accordingly, this description is to be construed as illustrative only and is for the purpose of teaching those skilled in the art the best mode of carrying out the invention. Details of the structure may be varied substantially without departing from the spirit of the invention and the exclusive use of all modifications, which come within the scope of the appended claims, is reserved.

We claim:

1. A method for automatic remote monitoring and control of the environment of ventilated racks of animal cages and corresponding equipment through wireless interfaces, the method comprising the following steps:
querying a plurality of status parameters of a ventilated rack of animal cages;
communicating the plurality of status parameters wirelessly to an access point;
evaluating the plurality of status parameters automatically;
alerting a digital system of the plurality of status parameters;
receiving control input from the digital system; and
communicating the control input wirelessly from the access point to the ventilated rack of animal cages;
wherein the environment of the ventilated racks of animal cages and corresponding equipment is remotely monitored.

2. The method for automatic remote monitoring and control of the environment of ventilated racks of animal cages and corresponding equipment through wireless interfaces as recited in claim 1 wherein the step of alerting further comprises alerting the digital system in response to at least one of the plurality of status parameters being outside of a predetermined range.

3. The method for automatic remote monitoring and control of the environment of ventilated racks of animal cages and corresponding equipment through wireless interfaces as recited in claim 1 wherein the step of alerting further comprises determining rate of change of at least one of the plurality of status parameters being outside of a predetermined range.

4. The method for automatic remote monitoring and control of the environment of ventilated racks of animal cages and corresponding equipment through wireless interfaces as recited in claim 1 wherein the step of communicating wirelessly uses IEEE 802.15 protocol.

5. The method for automatic remote monitoring and control of the environment of ventilated racks of animal cages and corresponding equipment through wireless interfaces as recited in claim 1 wherein at least one of the plurality of status parameters of a ventilated rack of animal cages is air change per hour.

6. The method for automatic remote monitoring and control of the environment of ventilated racks of animal cages and corresponding equipment through wireless interfaces as recited in claim 1 wherein at least one of the plurality of status parameters of a ventilated rack of animal cages is cage security.

7. The method for automatic remote monitoring and control of the environment of ventilated racks of animal cages and corresponding equipment through wireless interfaces as recited in claim 1 wherein at least one of the plurality of status parameters of a ventilated rack of animal cages is location/position of the ventilated rack.

8. A system for automatic remote monitoring and control of the environment of ventilated racks of animal cages and corresponding equipment through wireless interfaces, the system comprising:
query means for querying a plurality of status parameters of a ventilated rack of animal cages;
evaluation means for evaluating the plurality of status parameters automatically;
alert means for alerting a digital system of the plurality of status parameters;
receiving means receiving control input from the digital system; and
wireless interface for communicating the plurality of status parameters wirelessly to an access point and for communicating the control input wirelessly from the access point to the ventilated rack of animal cages;
wherein the environment of the ventilated racks of animal cages and corresponding equipment is remotely monitored.

9. The system for automatic remote monitoring and control of the environment of ventilated racks of animal cages and corresponding equipment through wireless interfaces as recited in claim 8 wherein the alert means is a function responsive to at least one of the plurality of status parameters being outside of a predetermined range.

10. The system for automatic remote monitoring and control of the environment of ventilated racks of animal cages and corresponding equipment through wireless interfaces as recited in claim 8 wherein the alert means is a function responsive to rate of change of at least one of the plurality of status parameters being outside of a predetermined range.

11. The system for automatic remote monitoring and control of the environment of ventilated racks of animal cages and corresponding equipment through wireless interfaces as recited in claim 8 wherein wireless interface uses IEEE 802.15 protocol.

12. The system for automatic remote monitoring and control of the environment of ventilated racks of animal cages and corresponding equipment through wireless interfaces as recited in claim 8 wherein at least one of the plurality of status parameters of a ventilated rack of animal cages is air change per hour.

13. The system for automatic remote monitoring and control of the environment of ventilated racks of animal cages and corresponding equipment through wireless interfaces as recited in claim 8 wherein at least one of the plurality of status parameters of a ventilated rack of animal cages is cage security.

14. The system for automatic remote monitoring and control of the environment of ventilated racks of animal cages and corresponding equipment through wireless interfaces as recited in claim 8 wherein at least one of the plurality of status parameters of a ventilated rack of animal cages is location/position of the ventilated rack.

15. A device for automatic remote monitoring and control of the environment of ventilated racks of animal cages and corresponding equipment through wireless interfaces in combination with ventilated racks of animal cages, the device comprising:
query means for querying a plurality of status parameters of a ventilated rack of animal cages;
evaluation means for evaluating the plurality of status parameters automatically;
alert means for alerting a digital system of the plurality of status parameters;
receiving means receiving control input from the digital system; and
wireless interface for communicating the plurality of status parameters wirelessly to an access point and for communicating the control input wirelessly from the access point to the ventilated rack of animal cages;
wherein the environment of the ventilated racks of animal cages and corresponding equipment is remotely monitored.

16. The device for automatic remote monitoring and control of the environment of ventilated racks of animal cages and corresponding equipment through wireless interfaces in combination with ventilated racks of animal cages, as recited in claim 15 wherein the alert means is a function responsive to at least one of the plurality of status parameters being outside of a predetermined range.

17. The device for automatic remote monitoring and control of the environment of ventilated racks of animal cages and corresponding equipment through wireless interfaces in combination with ventilated racks of animal cages, as recited in claim 15 wherein the alert means is a function responsive to rate of change of at least one of the plurality of status parameters being outside of a predetermined range.

18. The device for automatic remote monitoring and control of the environment of ventilated racks of animal cages and corresponding equipment through wireless interfaces in combination with ventilated racks of animal cages, as recited in claim 15 wherein wireless interface uses IEEE 802.15 protocol.

19. The device for automatic remote monitoring and control of the environment of ventilated racks of animal cages and corresponding equipment through wireless interfaces in combination with ventilated racks of animal cages, as recited in claim 15 wherein at least one of the plurality of status parameters of a ventilated rack of animal cages is air change per hour.

20. The device for automatic remote monitoring and control of the environment of ventilated racks of animal cages and corresponding equipment through wireless interfaces in combination with ventilated racks of animal cages, as recited in claim 15 wherein at least one of the plurality of status parameters of a ventilated rack of animal cages is cage security.
